(19) United States
(12) Patent Application Publication
(10) Pub. No.: US 2024/0012511 A1
(43) Pub. Date: Jan. 11, 2024

(54) DETECTION DEVICE

(71) Applicant: Panasonic Intellectual Property Management Co., Ltd., Osaka (JP)

(72) Inventor: Yusuke MORIOKA, Kanagawa (JP)

(73) Assignee: Panasonic Intellectual Property Management Co., Ltd., Osaka (JP)

(21) Appl. No.: 18/371,272

(22) Filed: Sep. 21, 2023

Related U.S. Application Data
(63) Continuation of application No. PCT/JP2021/035884, filed on Sep. 29, 2021.

(30) Foreign Application Priority Data
Mar. 23, 2021 (JP) 2021-048250

(51) Int. Cl. G06F 3/041; G06F 3/044

(52) U.S. Cl. CPC G06F 3/041662; G06F 3/0412; G06F 3/044; G06F 2203/04108

(57) ABSTRACT

A detection device performs detection of proximity of an object to a display device. The display device includes a common electrode group including a plurality of common electrodes that are arranged in a matrix and used for both image display and touch detection. The common electrode group includes a first group that includes a plurality of common electrodes and also includes a second group that includes a plurality of common electrodes different from those of the first group. A drive circuit supplies a drive signal to a plurality of common electrodes included in the first group. A detection circuit performs detection of proximity of an object to the display device, based on a detection signal received from a plurality of common electrodes included in the second group.

### CROSS-REFERENCE TO RELATED APPLICATIONS

This application is a Continuation of International Application No. PCT/JP2021/035884, filed on Sep. 29, 2021, which in turn claims the benefit of Japanese Application No.2021-048250, filed on Mar. 23, 2021, the disclosures of which Applications are incorporated by reference herein.

### BACKGROUND

### 1. Field

The present disclosure relates to a detection device provided with a touch detection function and a proximity detection function.

### 2. Description of the Related Art

A display device equipped with a display panel and a proximity sensor used to detect a touch and proximity of a detection target is known (see Patent Literature 1, for example). In this display device, electrodes for touch detection are arranged in a display region of the display panel, and electrodes for proximity detection are arranged outside the display region. When proximity detection is performed, a signal is input to the electrodes for touch detection, and the presence or absence of proximity of the detection target is judged based on a signal output from the electrodes for proximity detection.

Patent Literature 1: Japanese Unexamined Patent Application Publication No. 2019-101532

### SUMMARY

In the technologies for performing touch detection and proximity detection, further improvement has been required.

To solve the problem above, a detection device according to one aspect of the present disclosure performs detection of proximity of an object to a display device. The display device includes a common electrode group including a plurality of common electrodes that are arranged in a matrix and used for both image display and touch detection. The common electrode group includes a first group that includes a plurality of common electrodes and also includes a second group that includes a plurality of common electrodes different from those of the first group.

The detection device includes: a drive circuit that supplies a drive signal to a plurality of common electrodes included in the first group; and a detection circuit that performs detection of proximity of an object to the display device, based on a detection signal received from a plurality of common electrodes included in the second group.

Another aspect of the present disclosure is also a detection device. The detection device performs detection of proximity of an object to a display device. The display device includes a common electrode group including a plurality of common electrodes that are arranged in a matrix and used for both image display and touch detection. The common electrode group includes a first group that includes a plurality of common electrodes and also includes a second group that includes a plurality of common electrodes different from those of the first group. The detection device includes: a drive circuit that supplies a drive signal to a plurality of common electrodes included in the first group; and a detection circuit that performs detection of proximity of an object to the display device based on a detection signal. On a display surface of the display device, a dial, which is rotatable, is disposed to overlap at least one common electrode included in the second group. At a position on the dial that faces the display surface, an electric conductor is disposed. The detection circuit receives the detection signal from the electric conductor.

Yet another aspect of the present disclosure is also a detection device. The detection device performs detection of proximity of an object to at least one of a first display device or a second display device disposed adjacent to the first display device. The first display device includes a plurality of first common electrodes that are arranged in a matrix and used for both image display and touch detection. The second display device includes a plurality of second common electrodes that are arranged in a matrix and used for both image display and touch detection. The detection device includes: a drive circuit that supplies a drive signal to at least one of the plurality of first common electrodes; and a detection circuit that performs detection of proximity of an object to at least one of the first display device or the second display device, based on a detection signal received from at least one of the plurality of second common electrodes.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a display system according to a first embodiment;

FIG. 2 is a diagram that schematically shows a circuit configuration of a display device shown in FIG. 1;

FIG. 3 is a top view that shows arrangement of common electrodes shown in FIG. 2;

FIG. 4 is a longitudinal sectional view of the display device shown in FIG. 1;

FIG. 5 is a diagram that shows an operation of the display device shown in FIG. 1, during a touch detection period in a first mode;

FIG. 6 is a diagram that shows timings and a waveform of a first drive signal within a frame period in the first mode in the display device shown in FIG. 1;

FIG. 7 is a diagram that shows an operation in a second mode of the display device shown in FIG. 1;

FIG. 8 is a diagram that shows another operation in the second mode of the display device shown in FIG. 1;

FIG. 9 is a diagram that shows yet another operation in the second mode of the display device shown in FIG. 1;

FIG. 10 is a flowchart that shows mode switching processing performed in the display system shown in FIG. 1;

FIG. 11 is a diagram that shows an operation in the second mode of a display device in a second embodiment;

FIG. 12 is a block diagram of a display system in a third embodiment;

FIG. 13 is a diagram that shows an operation in the second mode of two display devices shown in FIG. 12;

FIG. 14 is a diagram that shows another operation in the second mode of the two display devices shown in FIG. 12; and

FIG. 15 is a diagram that shows an operation in the second mode of a display device in a modification.

### DETAILED DESCRIPTION

The invention will now be described by reference to the preferred embodiments. This does not intend to limit the scope of the present invention, but to exemplify the invention.

### Base Findings of Present Disclosure

Before specific description of embodiments is given, the underlying findings will be described. As described previously, there is a known technology in which, in order to perform proximity detection on a touch display using the mutual capacitance method, a signal is applied to each of multiple electrodes for touch detection arranged in a display region for an image so as to generate an electric field in a space in front of the display. Then, by reading a signal received from an electrode disposed outside the display region, a change in the electric field caused by proximity of a user's hand or the like to the display is detected. However, the inventor has found a problem of the area outside the display region becoming larger because the dedicated electrodes for proximity detection are arranged outside the display region, which may affect the design properties of the display. To solve the problem, a display system according to the present disclosure is configured as described below.

In the following, like reference characters denote like or corresponding constituting elements, members, and processes in each drawing, and repetitive description will be omitted as appropriate. Also, the dimensions of a member may be appropriately enlarged or reduced in each drawing in order to facilitate understanding.

### First Embodiment

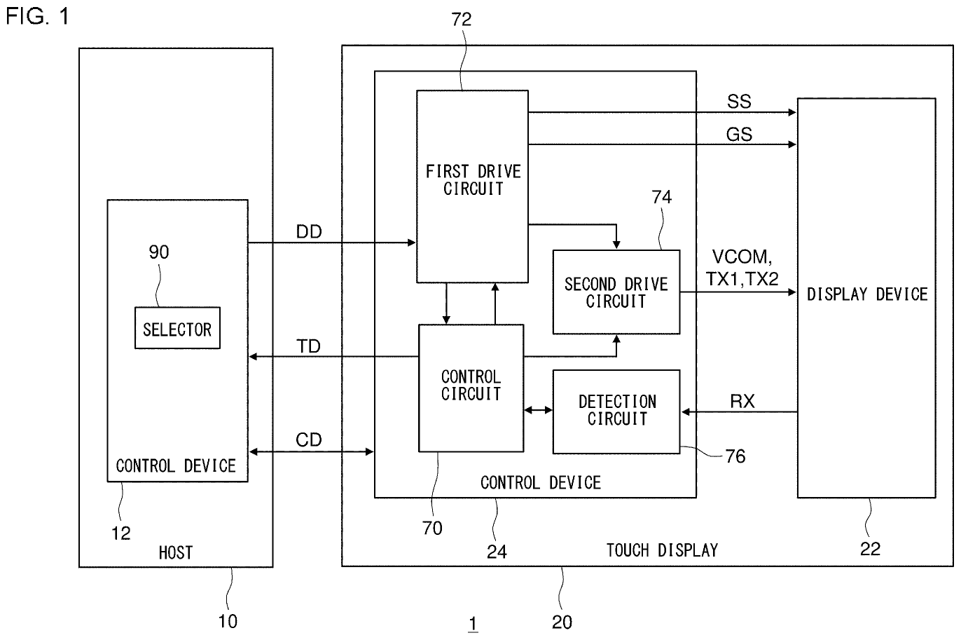

FIG. 1 is a block diagram of a display system 1 according to the first embodiment. Although an example will be described in which the display system 1 is a vehicle-mounted display system 1 mounted on a vehicle, such as an automobile, the application is not particularly limited. The display system 1 may also be used for a mobile device.

The display system 1 includes a host 10 and a touch display 20. The host 10 performs various functions, such as radio, car navigation, and Bluetooth (registered trademark) communication, and controls the touch display 20. The host 10 includes a control device 12.

The control device 12 may be a CPU, for example, and also called a host CPU. The control device 12 includes a selector 90 that selects an operation mode of the display system 1. The selector 90 selects a first mode in which image display and touch detection is performed, or a second mode in which image display is not performed but proximity detection is performed. The first mode can also be referred to as a touch detection mode, and the second mode can also be referred to as a proximity detection mode.

For example, the selector 90 selects the second mode until proximity of an object is detected in a standby state in which no image is displayed on the touch display and, when proximity is detected in the second mode, the selector 90 selects the first mode. When a condition for transition to the standby state is satisfied in the first mode, the selector 90 may select the second mode. The conditions on which the selector 90 selects the first mode or the second mode may be determined as appropriate, depending on the application of the display system 1. The first mode and the second mode will be detailed later.

The control device 12 supplies image data DD and control data CD, which includes operation mode information, to the touch display 20 and controls the touch display 20 based on such data. The control device 12 does not supply the image data DD in the second mode.

The touch display 20 includes a display device 22 and a control device 24. The display device 22 may be used as a center display on which a car navigation screen or the like is displayed within a vehicle cabin, for example.

The display device 22 is an in-cell liquid crystal display device of an in plane switching (IPS) type and capable of detecting a touch position. The configuration of the display device 22 may be a well-known configuration as described below, for example.

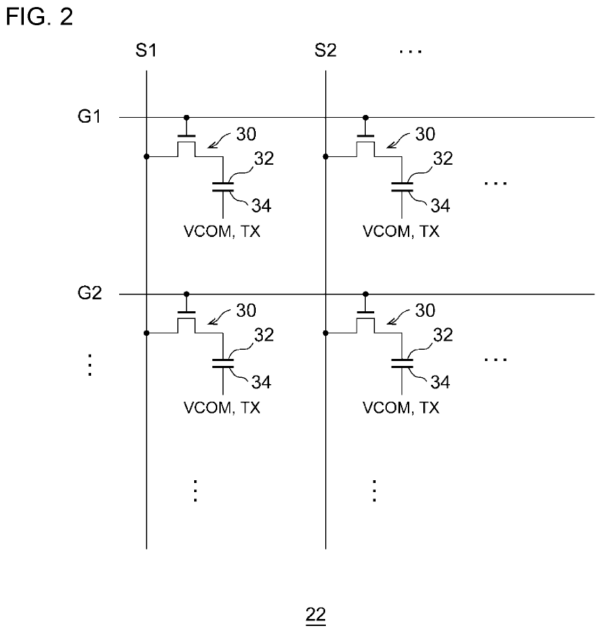

FIG. 2 schematically shows a circuit configuration of the display device 22 shown in FIG. 1. FIG. 2 also shows schematic arrangement of constituting elements. The display device 22 includes multiple gate lines G1, G2, and so on extending in a row direction, multiple source lines S1, S2, and so on extending in a column direction, multiple pixel switching elements 30, multiple pixel electrodes 32, and multiple common electrodes 34. Each pixel switching element 30 is a thin-film transistor provided near an intersection of a gate line and a source line such as to correspond to a pixel. In each pixel switching element 30, the gate is connected with a gate line, the source is connected with a source line, and the drain is connected with a pixel electrode 32. For one common electrode 34, multiple pixel switching elements 30 and multiple pixel electrodes 32 are arranged. The liquid crystal layer is controlled by means of electric fields between pixel electrodes 32 and common electrodes 34. The common electrodes 34 are used for both image display and touch detection. Accordingly, the number of electrode layers can be reduced, so that the display device 22 can be made thinner.

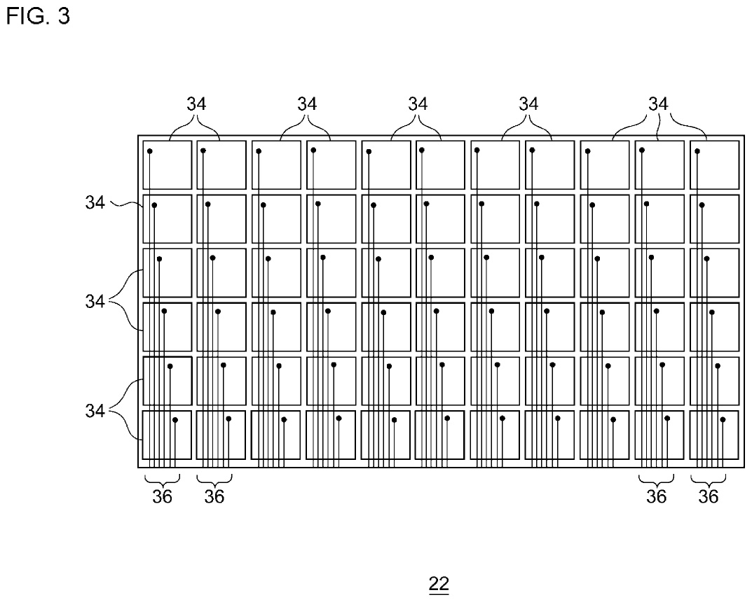

FIG. 3 is a top view that shows arrangement of common electrodes 34 shown in FIG. 2. The multiple common electrodes 34 are arranged in a matrix. Each common electrode 34 is connected to the control device 24 with a signal line 36.

In the first mode, the display device 22 detects a touch position of an object based on the self-capacitance method. When a finger is brought closer to the display surface of the display device 22, capacitance is formed between a common electrode 34 and the finger. The formation of capacitance increases parasitic capacitance in the common electrode 34, so that the current flowing when a drive signal is supplied to the common electrode 34 is increased. Based on the current variation, the touch position is detected.

In the second mode, the display device 22 detects a proximity position of an object based on the mutual capacitance method. The proximity detection will be detailed later.

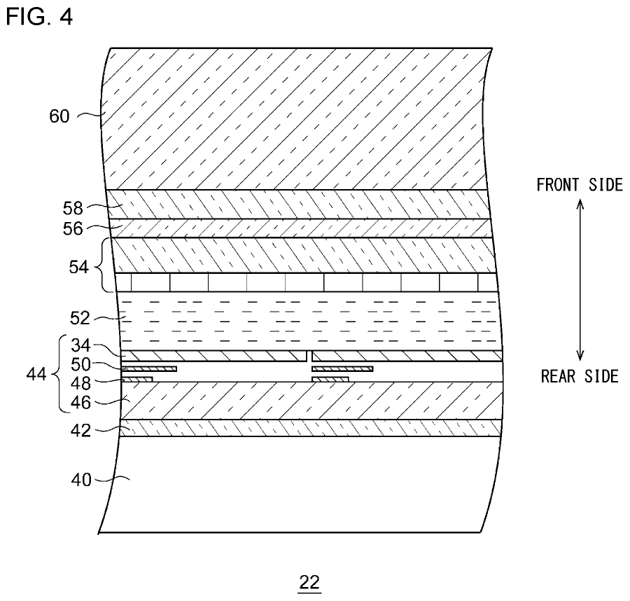

FIG. 4 is a longitudinal sectional view of the display device 22 shown in FIG. 1. The display device 22 includes a backlight unit 40, a lower polarizer 42, a thin-film transistor substrate (hereinafter, referred to as a TFT substrate) 44, a liquid crystal layer 52, a color filter substrate 54, an upper polarizer 56, a bonding layer 58, and a protection layer 60, which are laminated and disposed in this order along a depth direction.

In the following, with regard to the depth directions of the display device 22, the side on which the protection layer 60 is positioned with respect to the TFT substrate 44 is defined as the front side, and the opposite side is defined as the rear side.

Using the light emitted from the backlight unit 40, the display device 22 emits image light toward the front side, or the viewer side.

The TFT substrate 44 includes a glass substrate 46 and also includes multiple gate electrodes 48, multiple source electrodes 50, and multiple common electrodes 34, which are arranged on the front side of the glass substrate 46. The TFT substrate 44 also includes the multiple gate lines G1, G2, and so on, the multiple source lines S1, S2, and so on, the multiple pixel electrodes 32, and the multiple pixel switching elements 30 shown in FIG. 2, though illustration thereof is omitted. The liquid crystal layer 52 disposed on the front side of the TFT substrate 44 is controlled by means of lateral electric fields that occur between pixel electrodes 32 and common electrodes 34.

The bonding layer 58 has translucency and bonds the upper polarizer 56 and the protection layer 60. The bonding layer 58 may be formed by curing a transparent resin in a liquid state, such as optically clear resin (OCR), or curing a transparent adhesive sheet, such as optically clear adhesive (OCA), for example.

The protection layer 60 is a layer that has translucency and protects the display device 22, and the protection layer 60 is constituted by a glass substrate or a plastic substrate, for example. The protection layer 60 is also called a cover lens or the like.

The description now returns to FIG. 1. The control device 24 may be configured as an IC, for example, and controls the display device 22 based on the control data CD and the image data DD from the host 10. The control device 24 can also be referred to as a detection device that performs touch detection and proximity detection. The control device 24 includes a control circuit 70, a first drive circuit 72, a second drive circuit 74, and a detection circuit 76.

The control circuit 70 may be constituted by a microcomputer, for example, and controls signal generation timings of the first drive circuit 72 and the second drive circuit 74, touch or proximity detection timings of the detection circuit 76, and the like.

In the first mode, the control circuit 70 controls the first drive circuit 72, the second drive circuit 74, and the detection circuit 76 such that, during a frame period (one frame period), one frame of a display image is rendered on the display device 22 and touch detection for one screen is performed at least once. The frame period can also be referred to as a vertical synchronization period. The frame period will be detailed later.

In the second mode, the control circuit 70 controls the first drive circuit 72, the second drive circuit 74, and the detection circuit 76 such that the display by the display device 22 is stopped, and proximity detection is performed.

The first drive circuit 72 generates a reference clock signal under the control of the control circuit 70. In the first mode, the first drive circuit 72 also generates, under the control of the control circuit 70, a source signal SS in synchronization with the generated reference clock signal, based on the image data DD from the host 10. In the first mode, the first drive circuit 72 also generates, under the control of the control circuit 70, a gate signal GS in synchronization with the generated reference clock signal. The first drive circuit 72 supplies the generated source signal SS serially to multiple source lines in the display device 22 and also supplies the generated gate signal GS serially to multiple gate lines in the display device 22. In the second mode, the first drive circuit 72 stops generation and supply of the source signal SS and the gate signal GS.

The first drive circuit 72 supplies the reference clock signal to the second drive circuit 74. In the first mode, the second drive circuit 74 generates a reference voltage VCOM, which is a predetermined fixed voltage, and a first drive signal TX1 in synchronization with the reference clock signal, under the control of the control circuit 70. The first drive signal TX1 can also be referred to as a touch drive signal. The first drive signal TX1 may be a square wave signal or may be a sine wave signal. In the first mode, through the signal lines 36 shown in FIG. 3, the second drive circuit 74 supplies the reference voltage VCOM or the first drive signal TX1 to each of the multiple common electrodes 34 of the entire display device 22.

In the second mode, the multiple common electrodes 34 of the entire display device 22 are divided into a first group, a second group, and a third group. In the second mode, the second drive circuit 74 generates a second drive signal TX2 in synchronization with the reference clock signal under the control of the control circuit 70 and supplies the second drive signal TX2 to each of the multiple common electrodes 34 in the first group through the signal lines 36. The waveform, amplitude, and frequency of the second drive signal TX2 may be appropriately determined through experiments or simulations so that desired proximity detection performance can be obtained and may be the same as or different from the waveform and the like of the first drive signal TX1. In the second mode, since it is assumed that the display device 22 does not display images, the second drive circuit 74 does not supply the reference voltage VCOM to the multiple common electrodes 34.

In the first mode, the detection circuit 76 detects a touch by an object on the display device 22. In the first mode, under the control of the control circuit 70, the detection circuit 76 performs detection of a touch by an object on a position corresponding to a common electrode 34, based on a detection signal RX received from the common electrode 34 when the first drive signal TX1 is supplied to each common electrode 34. The detection circuit 76 outputs information on a detected touch position to the control circuit 70.

In the second mode, the detection circuit 76 detects proximity of an object to the display device 22. In the second mode, under the control of the control circuit 70, the detection circuit 76 performs detection of proximity of an object to a position corresponding to a common electrode 34 in the second group, based on a detection signal RX received from the common electrode 34 in the second group when the second drive signal TX2 is supplied to each common electrode 34 in the first group. The detection circuit 76 outputs information on a detected proximity position to the control circuit 70. The detection circuit 76 need not necessarily detect the proximity position. The detection circuit 76 may judge the presence or absence of proximity of an object and output, to the control circuit 70, information indicating the detection of proximity.

In the first mode, based on the touch position information from the detection circuit 76, the control circuit 70 derives coordinate data TD of the touch position and outputs the coordinate data TD to the control device 12 in the host 10. In the second mode, based on the proximity position information from the detection circuit 76, the control circuit 70 derives coordinate data TD of the proximity position and outputs the coordinate data TD to the control device 12 in the host 10. The control device 12 performs various processes according to the coordinate data TD.

The configurations of the control device 12 and the control circuit 70 can be implemented by cooperation between hardware resources and software resources or only by hardware resources. As the hardware resources, analog devices, microcomputers, DSPs, ROMs, RAMs, FPGAs, or other LSIs can be employed. As the software resources, programs, such as firmware, can be employed.

In the following, the first mode and the second mode will be detailed in turn.

### First Mode

In the first mode, the control circuit 70 alternately repeats partial image display on one of multiple display regions within the screen and partial touch detection on one of multiple touch detection regions within the screen, so as to control the image display and the touch detection in a time division manner.

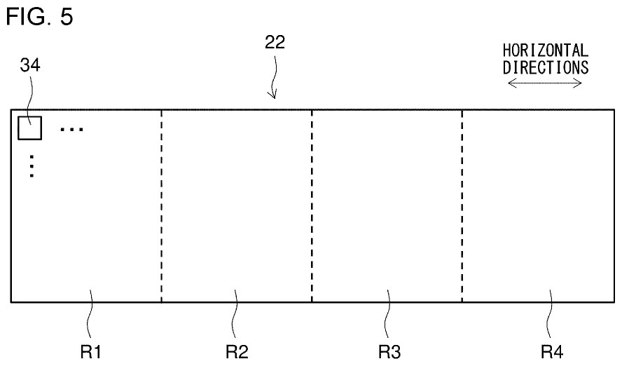

FIG. 5 is a diagram that shows an operation of the display device 22 shown in FIG. 1, during a touch detection period in the first mode. The display device 22 includes touch detection regions R1, R2, R3, and R4, which are configured by dividing the multiple common electrodes 34 within the screen into multiple groups. In FIG. 5, one common electrode 34 is shown, and the illustration of the other common electrodes 34 is omitted.

The touch detection regions R1, R2, R3, and R4 are horizontally arranged in this order from the left to the right when viewed from the viewer. Among the multiple common electrodes 34 of the entire display device 22, multiple common electrodes 34 are arranged in each of the touch detection regions R1 through R4. The number of touch detection regions in the display device 22 is not limited to “four”.

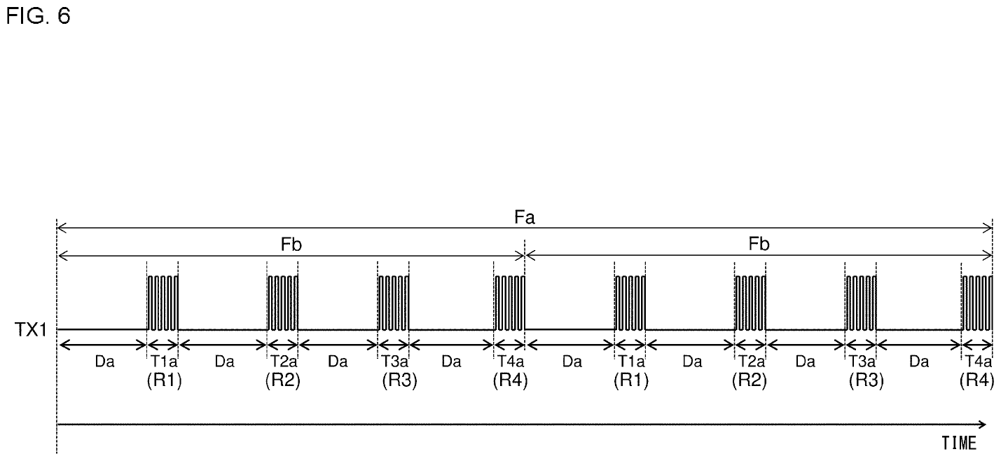

FIG. 6 shows timings and a waveform of the first drive signal TX1 within a frame period Fa in the first mode of the display device 22 shown in FIG. 1. In the example shown in FIG. 6, within a frame period Fa, one image is displayed, and touch detection for one screen is performed twice. In the present embodiment, the display device 22 is assumed to be a display device driven at 60 Hz to display an image, so that a frame period Fa is set to about 16.7 (=1/60) ms. Since the touch detection for one screen is performed twice within a frame period Fa, the touch detection is performed with a period of about 8.3 (=1/120) ms.

A frame period Fa is divided into two sub-frame periods Fb. Each sub-frame period Fb includes four display periods Da and four touch detection periods T1a, T2a, T3a, and T4a. The display periods Da and the touch detection periods are alternately arranged. In each sub-frame period Fb, the display period Da, touch detection period Tia, display period Da, touch detection period T2a, display period Da, touch detection period T3a, display period Da, and touch detection period T4a are arranged in this order. The number of display periods Da and the number of touch detection periods in a frame period Fa are not limited to “eight”.

The display device 22 displays one-eighth of a frame for each display period Da. Accordingly, one frame is displayed in the eight display periods Da within a frame period Fa. More specifically, during a display period Da, the first drive circuit 72 supplies the source signal SS to the multiple source lines and also supplies the gate signal GS to corresponding gate lines, and the second drive circuit 74 supplies the reference voltage VCOM to the multiple common electrodes 34. The second drive circuit 74 stops supply of the first drive signal TX1 during the display periods Da.

During each touch detection period, the second drive circuit 74 supplies the first drive signal TX1 to the multiple common electrodes 34 in the touch detection regions R1 through R4. The second drive circuit 74 stops supply of the reference voltage VCOM during each touch detection period.

During the touch detection period T1a, the detection circuit 76 performs detection of a touch by an object on the touch detection region R1, based on a detection signal RX received from the multiple common electrodes 34 in the touch detection region R1. During the touch detection period T2a, the detection circuit 76 performs detection of a touch by an object on the touch detection region R2, based on a detection signal RX received from the multiple common electrodes 34 in the touch detection region R2.

During the touch detection period T3a, the detection circuit 76 performs detection of a touch by an object on the touch detection region R3, based on a detection signal RX received from the multiple common electrodes 34 in the touch detection region R3. During the touch detection period T4a, the detection circuit 76 performs detection of a touch by an object on the touch detection region R4, based on a detection signal RX received from the multiple common electrodes 34 in the touch detection region R4.

Thus, during each of the multiple touch detection periods, the detection circuit 76 performs touch detection in a touch detection region different for each touch detection period. The display device 22 may include touch detection regions equal in number to the touch detection periods in a frame period Fa, and, in this case, the touch detection for one screen is performed once during the multiple touch detection periods in a frame period Fa.

### Second Mode

In the second mode, the display device 22 does not display an image, and the detection circuit 76 performs proximity detection instead of touch detection.

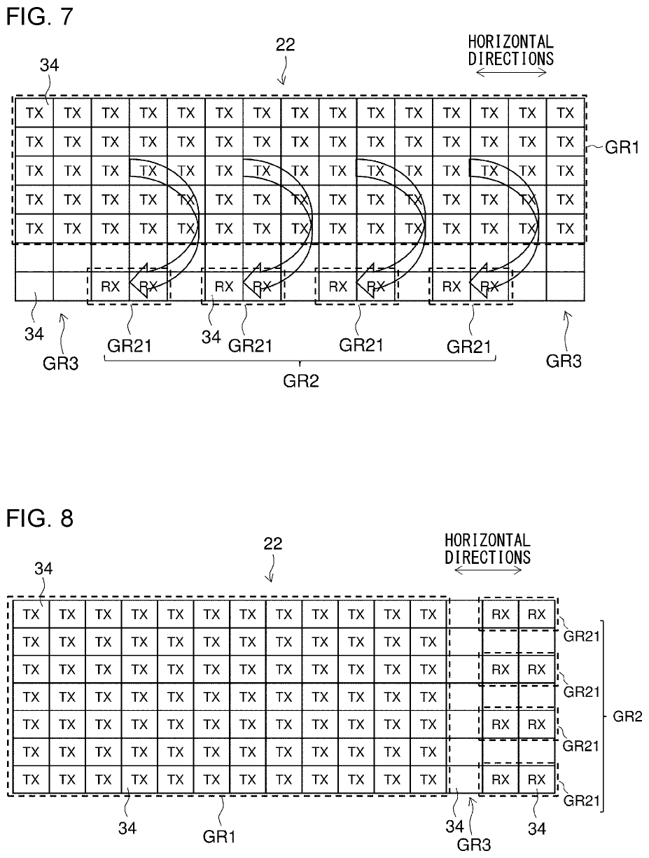

FIG. 7 is a diagram that shows an operation in the

second mode of the display device 22 shown in FIG. 1. FIG. 7 schematically illustrates the multiple common electrodes 34 of the entire screen viewed from the viewer side. The multiple common electrodes 34 are divided into a first group GR1, a second group GR2, and a third group GR3. The number of common electrodes 34 in the first group GR1 is larger than the number of common electrodes 34 in the second group GR2 and also larger than the number of common electrodes 34 in the third group GR3.

In this example, the first group GR1 includes multiple common electrodes 34 located in an area larger than the upper half of the screen. In FIG. 7, each of the common electrodes 34 in the first group GR1 is marked with “TX”.

The second group GR2 includes common electrodes 34 located in an edge part, among the multiple common electrodes 34 of the entire screen. The second group includes multiple common electrodes 34 located in a lower edge part of the screen. In FIG. 7, each of the common electrodes 34 in the second group GR2 is marked with “RX”.

The multiple common electrodes 34 in the second group GR2 are divided into four first subgroups GR21 arranged horizontally. The number of first subgroups GR21 is not limited to “four”. Each first subgroup GR21 includes two common electrodes 34 horizontally adjacent to each other.

The multiple common electrodes 34 of the third group GR3 are the common electrodes 34 other than those of the first group GR1 and the second group GR2. Between the common electrodes 34 of the first group GR1 and the common electrodes 34 of the second group GR2, common electrodes 34 of the third group GR3 are located. In other words, the common electrodes 34 of the first group GR1 are not adjacent to the common electrodes 34 of the second group GR2. Also, between two first subgroups GR21, a common electrode 34 of the third group GR3 is located. In other words, the common electrodes 34 of two first subgroups GR21 are not adjacent to each other.

In the second mode, the second drive circuit 74 supplies the second drive signal TX2 to each of the common electrodes 34 in the first group GR1, among the multiple common electrodes 34. In the second mode, the second drive circuit 74 does not supply the second drive signal TX2 to the common electrodes 34 in the second group GR2 and the third group GR3.

When the second drive signal TX2 is supplied, an electric field is generated between the common electrodes 34 of the first group GR1 and the common electrodes 34 of the second group GR2. In FIG. 7, a schematic electric field is indicated by arrows. Since the total area of the common electrodes 34 in the first group GR1 is larger than the total area of the common electrodes 34 in the second group GR2, the electric field can be generated over a relatively large region and can be generated at a distance from the display surface of the display device 22 in the normal direction thereof, i.e., in a space on the front side of the display device 22. Therefore, an object in proximity to the display surface affects the electric field, even if the object is not in contact with the display surface.

In the second mode, the detection circuit 76 performs detection of proximity of an object to the display device 22, based on a detection signal RX received from the common electrodes 34 in the second group GR2 among the multiple common electrodes 34. When the presence of an object in proximity to the display surface affects the electric field, the detection signal RX changes, compared to the case where the object is not present. By detecting such a change, the detection circuit 76 detects proximity of an object. Also in the first mode, even if an object does not touch the display surface, if the object comes close enough to the display surface to cause a detectable increase in parasitic capacitance, it could be detected that there has been a touch. In the second mode, however, proximity over a distance longer than the distance between the display surface and an object that is detectable in the first mode can also be detected. For the proximity detection using the detection signal RX, a publicly-known technology can be employed.

The detection circuit 76 does not distinguish between detection signals received from the respective common electrodes 34 in one first subgroup GR21. Meanwhile, the detection circuit 76 can distinguish between detection signals received from common electrodes 34 in different two first subgroups GR21. Therefore, in the second mode, the detection circuit 76 may detect a first subgroup GR21 to which there was proximity of an object, from among the multiple first subgroups GR21. Accordingly, in addition to the presence or absence of proximity of an object, a schematic position where an object was in proximity can also be identified. The position where an object was in proximity can be determined based on the position of each of the multiple common electrodes 34 in a detected first subgroup GR21, which may be, for example, the center of gravity of the position coordinates of the common electrode. When a schematic position where an object was in proximity is identified, the control device 12 may determine the display content in the first mode based on the identified position.

In the second mode, the detection circuit 76 does not use a detection signal RX from the common electrodes 34 in the third group GR3, for detection of proximity of an object. In the second mode, the common electrodes 34 in the third group GR3 may not be electrically connected to the detection circuit 76.

There will now be described another example of division into the first group GR1, second group GR2, and third group GR3. FIG. 8 is a diagram that shows another operation in the second mode of the display device 22 shown in FIG. 1. The first group GR1 includes multiple common electrodes 34 located in an area larger than the left half of the screen.

The second group GR2 includes multiple common electrodes 34 located in a right edge part of the screen. The multiple common electrodes 34 in the second group GR2 are divided into four first subgroups GR21.

In the example of FIG. 8, when an object approaches from the right side of the screen where the multiple common electrodes 34 of the second group GR2 are located, the proximity is likely to be detected with higher sensitivity than when the object approaches from the left side of the screen. Therefore, when the display device 22 is used as a center display in the cabin of a right-hand drive vehicle, for example, proximity of a hand of the vehicle's driver is more likely to be detected.

Depending on the direction in which proximity detection with high sensitivity is required, the second group GR2 may include multiple common electrodes 34 in a left or lower edge part, instead of the right edge part, of the screen.

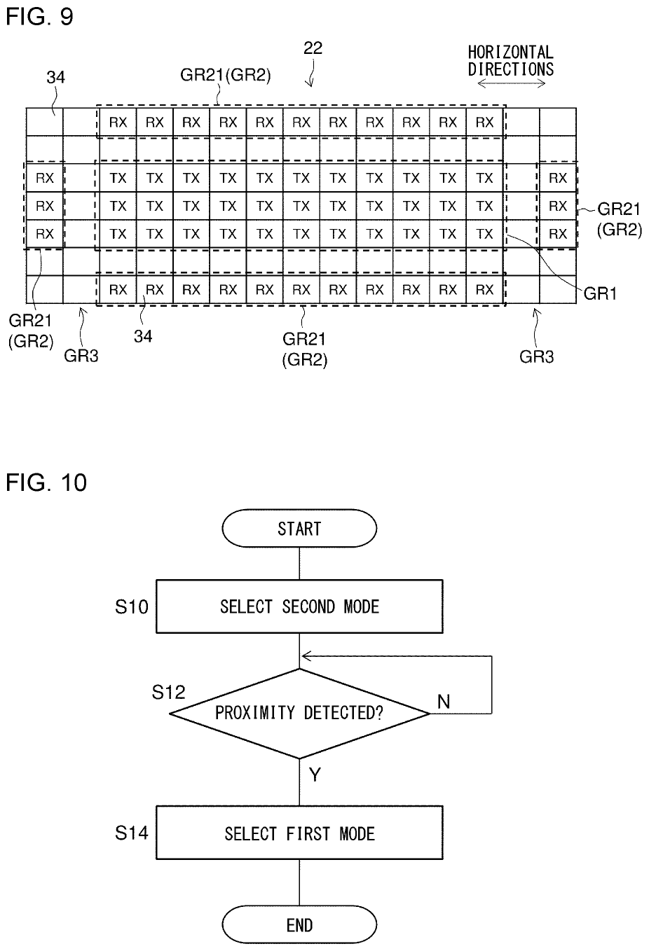

FIG. 9 is a diagram that shows yet another operation in the second mode of the display device 22 shown in FIG. 1. The second group GR2 includes multiple common electrodes 34 located in upper, lower, right, and left edge parts of the screen. The multiple common electrodes 34 of the second group GR2 are divided into a first subgroup GR21 in the upper edge part of the screen, a first subgroup GR21 in the lower edge part of the screen, a first subgroup GR21 in the left edge part of the screen, and a first subgroup GR21 in the right edge part of the screen.

In the example of FIG. 9, even when an object approaches from the upper, lower, right, or left side of the screen, the proximity is likely to be detected.

The second group GR2 may include multiple common electrodes 34 in two or three of the upper, lower, right, and left edge parts of the screen.

In the example of FIG. 9, when the detection circuit 76 has detected a first subgroup GR21 to which there was proximity of an object, the control circuit 70 may divide multiple common electrodes 34 including one or more common electrodes 34 of the detected first subgroup GR21 into multiple second subgroups. When dividing the common electrodes 34 into multiple second subgroups, the control circuit 70 may increase the number of common electrodes 34 in the first group GR1, compared to before the division into the second subgroups.

For example, when proximity of an object is detected in the first subgroup GR21 in the right edge part of the screen shown in FIG. 9, the grouping may be changed to that shown in FIG. 8. More specifically, the three common electrodes 34 of the first subgroup GR21 in the right edge part of the screen shown in FIG. 9 and the eleven common electrodes 34 located therearound may be divided into four second subgroups and the third group GR3, as shown in FIG. 8, and the number of common electrodes 34 in the first group GR1 may be increased from the example of FIG. 9. In this case, the first subgroups GR21 in FIG. 8 correspond to the second subgroups.

In this case, based on a detection signal RX received from one or more common electrodes 34 in the multiple second subgroups divided by the control circuit 70, the detection circuit 76 detects a second subgroup to which there was proximity of an object, from among the multiple second subgroups.

Therefore, after the detection of whether an object was approaching from the upper, lower, right, or left side of the screen, the position where the object was in proximity can be identified more specifically. Also, by increasing the number of common electrodes 34 in the first group GR1 compared to before the division into the second subgroups, the second drive signal TX2 can be supplied to more common electrodes 34, so that the electric field can be generated over a larger region. Therefore, the sensitivity of proximity detection can be improved, and the region where proximity can be detected can be expanded.

There will now be described the overall operation of the display system 1 having the configuration set forth above. FIG. 10 is a flowchart that shows mode switching processing performed in the display system 1 shown in FIG. 1. The processing shown in FIG. 10 is initiated, for example, when the display system 1 is placed in a standby state in which no image is displayed. The selector 90 selects the second mode (S10), and, when proximity is not detected (N at S12), the process returns to S12. When proximity is detected (Y at S12), the selector 90 selects the first mode (S14).

According to the present embodiment, the second drive signal TX2 is supplied to the multiple common electrodes 34 in the first group GR1 among the multiple common electrodes 34 used for both image display and touch detection. Proximity of an object is detected based on a detection signal RX received from the multiple common electrodes 34 in the second group GR2. In other words, to perform proximity detection based on the mutual capacitance method, the multiple common electrodes 34 arranged in a matrix are divided into transmission electrodes and reception electrodes. Accordingly, there is no need to provide another sensor electrode for receiving the detection signal RX, around the multiple common electrodes 34. Therefore, the area around the display surface of the display device 22 can be made smaller, so that the design properties of the display device 22 can be enhanced.

Also, since the second drive signal TX2 is not supplied to the common electrodes 34 of the third group GR3 located between the common electrodes 34 of the first group GR1 and the common electrodes 34 of the second group GR2, the second drive signal TX2 is less likely to affect the detection signal RX. This can improve the proximity detection accuracy. Assuming that the common electrodes 34 of the third group GR3 do not exist, the common electrodes 34 of the first group GR1 and the common electrodes 34 of the second group GR2 will be adjacent. Accordingly, parasitic capacitance between adjacent common electrodes 34 will make the detection signal RX more likely to be affected by the second drive signal TX2. In this case, the detection accuracy is likely to be lower than that in the embodiment.

Also, since the second group GR2 includes common electrodes 34 located in an edge part among the multiple common electrodes arranged in a matrix, proximity of an object from a direction around the screen of the display device 22 is likely to be detected.

### Second Embodiment

The second embodiment differs from the first embodiment in that dials are arranged on the display surface of the display device 22, and proximity of an object is detected based on a detection signal received from an electric conductor provided in a dial. In the following, description will be given mainly for the differences from the first embodiment.

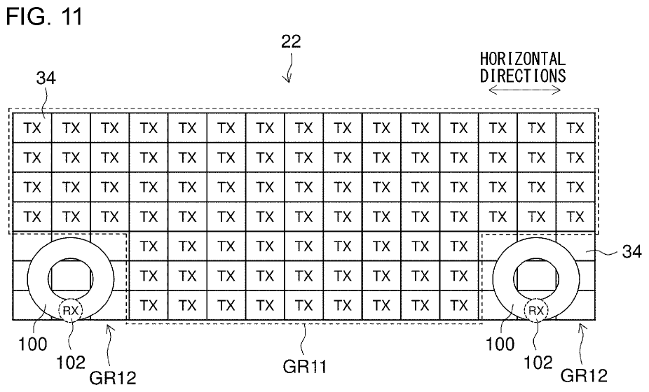

FIG. 11 is a diagram that shows an operation in the second mode of the display device 22 in the second embodiment. Multiple common electrodes 34 are divided into a first group GR11 and a second group GR12. The second group GR12 includes multiple common electrodes 34 located in lower right and lower left edge parts of the screen. The number of common electrodes 34 in the first group GR11 is larger than the number of common electrodes 34 in the second group GR12.

The display system 1 includes dials 100 that are rotatable and disposed respectively in a lower right region and a lower left region on the display surface of the display device 22. The number of dials 100 is not limited to “two”. The dials 100 may be used for temperature setting of an air conditioner in a vehicle, for example. Each dial 100 overlaps multiple common electrodes 34 in the second group GR12 among the multiple common electrodes 34 and does not overlap the common electrodes 34 in the first group GR11.

Each dial 100 is rotatable about a rotating shaft fixed on the display surface of the display device 22, in response to a user's operation. At a position on each dial 100 that faces the display surface of the display device 22, an electric conductor 102 is disposed. With the rotation of a dial 100, the corresponding electric conductor 102 also rotates about the rotating shaft. The operations in the first mode of the first drive circuit 72, the second drive circuit 74, and the detection circuit 76 are the same as in the first embodiment. In the first mode, the detection circuit 76 also detects, as a touch position, a rotating position of each dial 100, which corresponds to a position of each electric conductor 102.

In the second mode, the second drive circuit 74 supplies the second drive signal TX2 to the common electrodes 34 in the first group GR11 among the multiple common electrodes 34 and does not supply the second drive signal TX2 to the multiple common electrodes 34 in the second group GR12. In FIG. 11, each of the common electrodes 34 in the first group GR11 is marked with “TX”. When the second drive signal TX2 is supplied, an electric field is generated between common electrodes 34 in the first group GR11 and each electric conductor 102. An object in proximity to the display surface affects the electric field.

Each electric conductor 102 is connected to the detection circuit 76 by wiring, which is not illustrated. In the second mode, the detection circuit 76 performs detection of proximity of an object to the display device 22, based on a detection signal RX received from the electric conductors 102. The detection circuit 76 can identify which conductor 102 side there was proximity of an object to.

According to the present embodiment, in a configuration in which a rotating position of each dial 100, which corresponds to a position of each electric conductor 102, is detected as a touch position, proximity of an object is detected based on a detection signal RX received from the electric conductors 102. Accordingly, there is no need to provide another sensor electrode for receiving the detection signal RX, around the multiple common electrodes 34. Therefore, as in the first embodiment, the area around the display surface of the display device 22 can be made smaller.

Also, since the second drive signal TX2 is not supplied to the multiple common electrodes 34 of the second group GR12 that may overlap the electric conductors 102, interference with the spread of the electric field can be made difficult. Therefore, proximity can be detected in a larger area.

### Third Embodiment

The third embodiment differs from the first embodiment in that the display system 1 includes multiple display devices. In the following, description will be given mainly for the differences from the first embodiment.

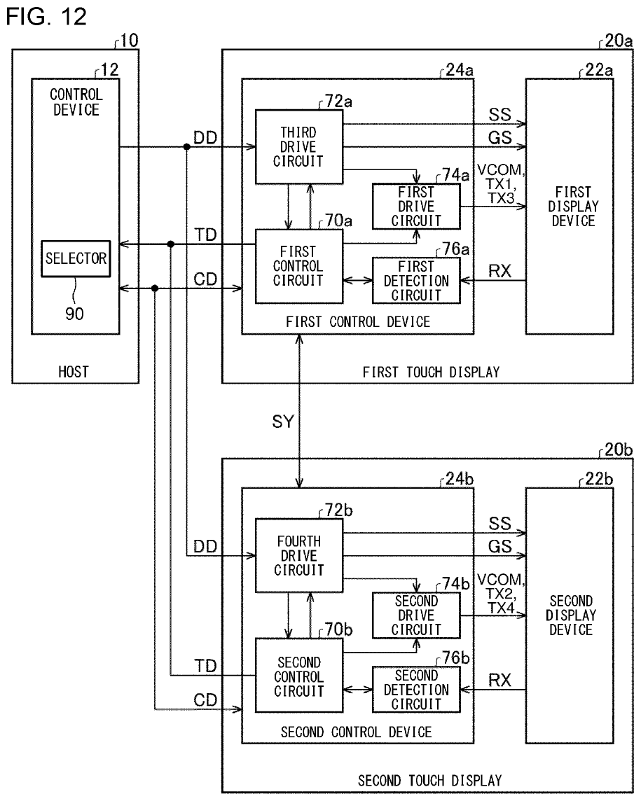

FIG. 12 is a block diagram of the display system 1 in the third embodiment. The display system 1 includes the host 10, a first touch display 20a, and a second touch display 20b. In the following, when the first touch display 20a and the second touch display 20b are not differentiated from each other, they may be referred to as touch displays 20.

The host 10 controls the two touch displays 20. The host 10 is disposed on a substrate separate from that for the first touch display 20a and the second touch display 20b, for example.

The control device 12 supplies image data DD and control data CD, which includes operation mode information, to the two touch displays 20 and controls the two touch displays 20 based on such data.

The first touch display 20a includes a first display device 22a and a first control device 24a. The second touch display 20b includes a second display device 22b and a second control device 24b. The configuration and functions of each of the first touch display 20a and the second touch display 20b are basically the same as those of the touch display 20 in the first embodiment. In the following, when the first display device 22a and the second display device 22b are not differentiated from each other, they may be referred to as display devices 22. Also, when the first control device 24a and the second control device 24b are not differentiated from each other, they may be referred to as control devices 24. The first control device 24a and the second control device 24b can also be collectively referred to as a detection device that performs touch detection and proximity detection.

The two display devices 22 may be used as center displays on which a car navigation screen or the like is displayed within a vehicle cabin, for example, and may be arranged horizontally or vertically adjacent to each other. The two display devices 22 may respectively display parts of one screen, such as a car navigation screen, so that the two screens form the one screen. Alternatively, one display device 22 may display a first screen, such as a car navigation screen, and the other display device 22 may display a second screen, such as a television screen, different from the first screen.

The first control device 24a may be configured as an IC, for example, and controls the first display device 22a based on the control data CD and the image data DD from the host 10. The first control device 24a includes a first control circuit 70a, a third drive circuit 72a, a first drive circuit 74a, and a first detection circuit 76a.

The first control circuit 70a may be constituted by a microcomputer, for example, and controls signal generation by the third drive circuit 72a and the first drive circuit 74a, timings of touch or proximity detection by the first detection circuit 76a, and the like.

The first control circuit 70a controls the third drive circuit 72a, the first drive circuit 74a, and the first detection circuit 76a such that, during a first frame period, one frame of a display image is rendered on the first display device 22a and touch detection for one screen is performed at least once. The first frame period can also be referred to as a first vertical synchronization period.

The third drive circuit 72a generates a first reference clock signal under the control of the first control circuit 70a. In the first mode, the third drive circuit 72a operates in the same manner as the first drive circuit 72 of the first embodiment, based on the first reference clock signal. Also, in the first mode, the first drive circuit 74a operates in the same manner as the second drive circuit 74 of the first embodiment based on the first reference clock signal and supplies the first drive signal TX1 to each of multiple first common electrodes of the first display device 22a.

In the first mode, the first detection circuit 76a performs detection of a touch by an object on a position corresponding to a first common electrode, based on the detection signal RX received from the first common electrode when the first drive signal TX1 is supplied to each first common electrode.

Based on the first reference clock signal, the third drive circuit 72a outputs a synchronization signal SY to the second control device 24b at the start timing of each first frame period, for example. The output timing of the synchronization signal SY is not particularly limited, as long as signals can be synchronized between the first control device 24a and the second control device 24b.

The second control device 24b may be configured as an IC, for example, and controls the second display device 22b based on the control data CD and the image data DD from the host 10 and the synchronization signal SY from the first control device 24a. The basic operations of the second control device 24b are the same as those of the first control device 24a. The second control device 24b includes a second control circuit 70b, a fourth drive circuit 72b, a second drive circuit 74b, and a second detection circuit 76b.

The second control circuit 70b may be constituted by a microcomputer, for example, and controls signal generation by the fourth drive circuit 72b and the second drive circuit 74b, timings of touch or proximity detection by the second detection circuit 76b, and the like, based on the synchronization signal SY. The second control circuit 70b and the aforementioned first control circuit 70a may be collectively referred to as control circuits.

The second control circuit 70b controls the fourth drive circuit 72b, the second drive circuit 74b, and the second detection circuit 76b such that, during a second frame period, one frame of a display image is rendered on the second display device 22b and touch detection for one screen is performed at least once. Based on the synchronization signal SY, the second control circuit 70b provides control such that the start timing of the second frame period coincides with the start timing of the first frame period. The second frame period can also be referred to as a second vertical synchronization period.

The fourth drive circuit 72b generates a second reference clock signal under the control of the second control circuit 70b. In the first mode, the fourth drive circuit 72b operates in the same manner as the first drive circuit 72 of the first embodiment, based on the second reference clock signal. Also, in the first mode, the second drive circuit 74b operates in the same manner as the second drive circuit 74 of the first embodiment based on the second reference clock signal and supplies the second drive signal TX2 to each of multiple second common electrodes of the second display device 22b.

In the first mode, the second detection circuit 76b performs detection of a touch by an object on a position corresponding to a second common electrode, based on the detection signal RX received from the second common electrode when the second drive signal TX2 is supplied to each second common electrode.

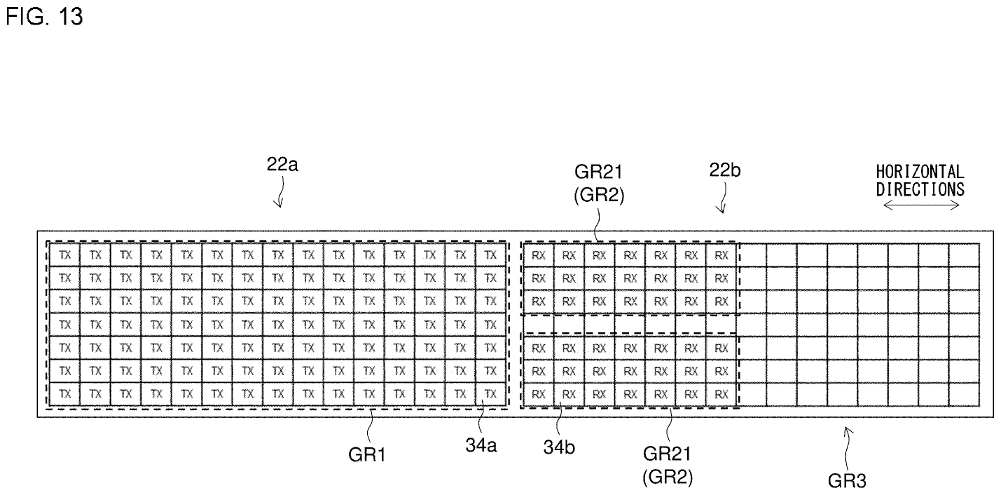

FIG. 13 is a diagram that shows an operation in the second mode of the two display devices 22 shown in FIG. 12. The first display device 22a and the second display device 22b are arranged horizontally adjacent to each other when viewed from the viewer.

Multiple first common electrodes 34a of the entire first display device 22a are included in the first group GR1. Multiple second common electrodes 34b of the second display device 22b are divided into the second group GR2 and the third group GR3. The number of first common electrodes 34a in the first group GR1 is larger than the number of second common electrodes 34b in the second group GR2. In the following, when the first common electrodes 34a and the second common electrodes 34b are not differentiated from each other, they may be referred to as common electrodes 34.

The second group GR2 includes second common electrodes 34b located in almost the left half of the screen of the second display device 22b. In order to increase the detection sensitivity, the second group GR2 may preferably include the second common electrodes 34b on the first display device 22a side. The multiple second common electrodes 34b in the second group GR2 are divided into two first subgroups GR21 arranged vertically. The number of first subgroups GR21 is not limited to “two”, and the second group GR2 may not be divided into the first subgroups GR21. Also, the second group GR2 may include second common electrodes 34b on almost the entire screen of the second display device 22b.

The third group GR3 includes the second common electrodes 34b other than those of the second group GR2. The second common electrodes 34b of the third group GR3 are located between the two first subgroups GR21. In other words, the second common electrodes 34b of the two first subgroups GR21 are not adjacent to each other. The arrangement of the first display device 22a and the second display device 22b may be horizontally inverted, and second common electrodes 34b located in almost the right half of the screen of the second display device 22b may be classified in the second group GR2.

In the second mode, the first drive circuit 74a supplies a third drive signal TX3 to at least one of the multiple first common electrodes 34a. In this example, the first drive circuit 74a supplies the third drive signal TX3 to all the first common electrodes 34a. In the second mode, the second drive circuit 74b does not supply any drive signal to the second common electrodes 34b.

In the second mode, the second detection circuit 76b performs detection of proximity of an object to at least one of the first display device 22a or the second display device 22b, based on a detection signal RX received from at least one of the multiple second common electrodes 34b. In this example, based on a detection signal RX received from the second common electrodes 34b in the second group GR2, as the at least one of the second common electrodes 34b, the second detection circuit 76b performs detection of proximity of an object to at least one of the first display device 22a or the second display device 22b. In the second mode, the first detection circuit 76a does not perform detection of proximity of an object.

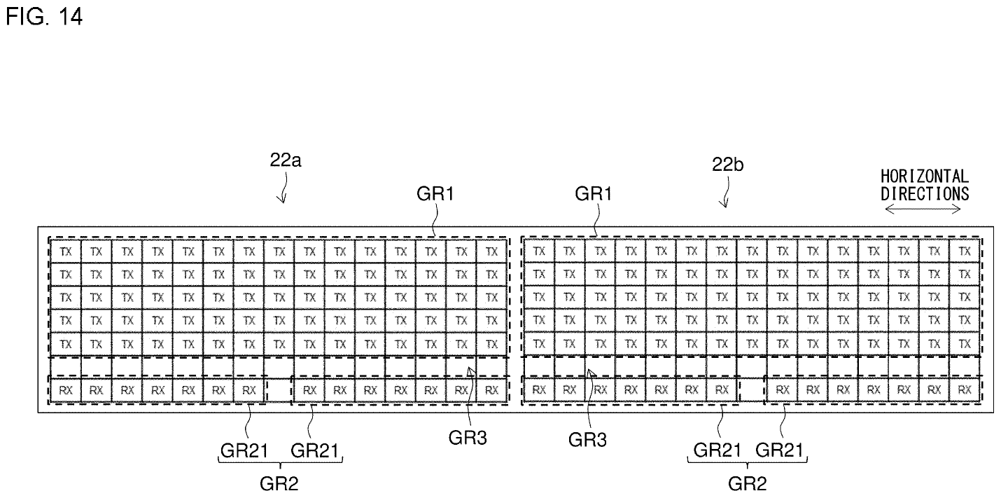

There will now be described another example of division into the first group GR1, second group GR2, and third group GR3. FIG. 14 is a diagram that shows another operation in the second mode of the two display devices 22 shown in FIG. 12. In each of the two display devices 22, the same grouping is conducted. In each of the two display devices 22, the first group GR1 includes multiple common electrodes 34 located in an area larger than the upper half of the screen.

In each of the two display devices 22, the second group GR2 includes multiple common electrodes 34 located in a lower edge part of the screen. The multiple common electrodes 34 in the second group GR2 are divided into two first subgroups GR21 arranged horizontally. Each first subgroup GR21 includes seven common electrodes 34 horizontally adjacent to each other.

In each of the two display devices 22, the multiple common electrodes 34 of the third group GR3 are the common electrodes 34 other than those of the first group GR1 and the second group GR2. Between the common electrodes 34 of the first group GR1 and the common electrodes 34 of the second group GR2, common electrodes 34 of the third group GR3 are located. Also, between the two first subgroups GR21, a common electrode 34 of the third group GR3 is located.

In the second mode, the first drive circuit 74a supplies the third drive signal TX3 to the first common electrodes 34a in the corresponding first group GR1. In the second mode, the second drive circuit 74b supplies a fourth drive signal TX4 to the second common electrodes 34b in the corresponding first group GR1.

In the second mode, the first detection circuit 76a performs detection of proximity of an object to the first display device 22a, based on a detection signal RX received from the first common electrodes 34a in the corresponding second group GR2. In the second mode, the second detection circuit 76b performs detection of proximity of an object to the second display device 22b, based on a detection signal RX received from the second common electrodes 34b in the corresponding second group GR2.

The grouping in each of the two display devices 22 may be the same as in the first embodiment.

According to the present embodiment, there is no need to provide another sensor electrode for receiving the detection signal RX, around the multiple first common electrodes 34a and around the multiple second common electrodes 34b. Therefore, the area around the display surface of each of the first display device 22a and the second display device 22b can be made smaller.

The present disclosure has been described with reference to embodiments. The embodiments are intended to be illustrative only, and it will be obvious to those skilled in the art that various modifications to a combination of constituting elements or processes in the embodiments could be developed and that such modifications also fall within the scope of the present disclosure.

For example, the second embodiment may be combined with the third embodiment. An additional embodiment made by such a combination has the effect of each of the combined embodiments.

Although the control device 24 is included in the touch display 20 in the first and second embodiments, the control device 24 may be included in the host 10. Also, although the first drive circuit 72 generates the reference clock signal in the first and second embodiments, the second drive circuit 74 may generate the reference clock signal. Also, the number of touch detection periods included in a frame period may be more than three times the number of touch detection regions in the display device 22. These are the same also in the third embodiment. In the third embodiment, three or more display devices 22 may be arranged adjacent to one another. These modifications allow greater flexibility in the configuration of the display system 1.

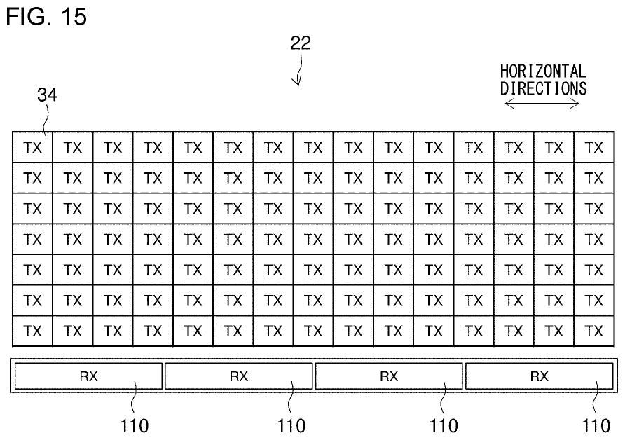

If there is no need to make the area around the display surface of each display device 22 smaller, sensor electrodes separate from the multiple common electrodes 34 may be arranged, as shown in FIG. 15. In the following, description will be given mainly for the differences from the first embodiment.

FIG. 15 is a diagram that shows an operation in the second mode of the display device 22 in a modification. Four sensor electrodes 110 are arranged outside the multiple common electrodes 34 on the display surface. The sensor electrodes 110 are arranged horizontally below the multiple common electrodes 34. In the positions of the sensor electrodes 110, no image is displayed.

In the second mode, the second drive circuit 74 supplies the second drive signal TX2 to each of the multiple common electrodes 34 of the entire screen. Accordingly, an electric field is generated between the multiple common electrodes 34 and the multiple sensor electrodes 110. In the second mode, the detection circuit 76 performs detection of proximity of an object to the display device 22, based on a detection signal RX received from the sensor electrodes 110. Also with this configuration, proximity detection can be performed on an in-cell touch display that includes common electrodes 34 arranged in a matrix.

A detection device according to one aspect of the present disclosure includes:
a drive circuit that supplies a drive signal to a common electrode in a first group, among multiple common electrodes of a display device, which are arranged in a matrix and used for both image display and touch detection; and
a detection circuit that performs detection of proximity of an object to the display device, based on a detection signal received from a common electrode in a second group different from the first group, among the multiple common electrodes.

According to this aspect, there is no need to provide another sensor electrode for receiving a detection signal, around the multiple common electrodes. Therefore, the area around the display surface of the display device can be made smaller.

In the detection device according to the one aspect of the present disclosure, for example,
between a common electrode in the first group and a common electrode in the second group, a common electrode in a third group may be located, and
the drive circuit may not supply a drive signal to a common electrode in the second group and a common electrode in the third group.

This case can restrain the second drive signal from affecting the detection signal. Therefore, the proximity detection accuracy can be improved.

In the detection device according to the one aspect of the present disclosure, for example,
multiple common electrodes in the second group may be divided into multiple first subgroups, and
the detection circuit may detect a first subgroup to which there was proximity of an object, from among the multiple first subgroups.

In this case, a schematic position where an object was in proximity can be identified.

In the detection device according to the one aspect of the present disclosure, for example,
a control circuit may be further included that divides, when the detection circuit has detected a first subgroup to which there was proximity of an object, multiple common electrodes including one or more common electrodes in the detected first subgroup, into multiple second subgroups, and
the detection circuit may detect a second subgroup to which there was proximity of an object, from among the multiple second subgroups, based on a detection signal received from one or more common electrodes in the multiple second subgroups divided by the control circuit.

In this case, when proximity is detected, a position where an object was in proximity can be identified more specifically.

In the detection device according to the one aspect of the present disclosure, for example,
when dividing common electrodes into the multiple second subgroups, the control circuit may increase the number of common electrodes in the first group.

In this case, compared to before the division into the second subgroups, the drive signal can be supplied to more common electrodes in the first group, so that the electric field can be generated over a larger region. Therefore, the sensitivity of proximity detection can be improved, and the region where proximity can be detected can be expanded.

In the detection device according to the one aspect of the present disclosure, for example,
a common electrode in the second group may include a common electrode located in an edge part, among the multiple common electrodes.

In this case, proximity of an object from a direction around the screen of the display device is likely to be detected.

In the detection device according to the one aspect of the present disclosure, for example,
a number of common electrodes in the first group may be larger than a number of common electrodes in the second group.

In this case, since the drive signal can be supplied to more common electrodes, the electric field can be generated over a larger region. Therefore, the sensitivity of proximity detection can be improved, and the region where proximity can be detected can be expanded.

A detection device according to one aspect of the present disclosure includes:
a drive circuit that supplies a drive signal to a common electrode in a first group, among multiple common electrodes of a display device, which are arranged in a matrix and used for both image display and touch detection; and
a detection circuit that performs detection of proximity of an object to the display device based on a detection signal, wherein
on a display surface of the display device, a dial, which is rotatable, is disposed to overlap a common electrode in a second group different from the first group, among the multiple common electrodes,
at a position on the dial that faces the display surface of the display device, an electric conductor is disposed, and
the detection circuit receives the detection signal from the electric conductor.

According to this aspect, there is no need to provide another sensor electrode for receiving a detection signal, around the multiple common electrodes. Therefore, the area around the display surface of the display device can be made smaller.

In the detection device according to the one aspect of the present disclosure, for example,
the drive circuit may not supply a drive signal to a common electrode in the second group.

In this case, interference with the spread of the electric field can be made difficult. Therefore, proximity can be detected in a larger area.

A detection device according to one aspect of the present disclosure includes:
a drive circuit that supplies a drive signal to at least one of multiple first common electrodes of a first display device, which are arranged in a matrix and used for both image display and touch detection; and
a detection circuit that performs detection of proximity of an object to at least one of the first display device or a second display device disposed adjacent to the first display device, based on a detection signal received from at least one of multiple second common electrodes of the second display device, which are arranged in a matrix and used for both image display and touch detection.

According to this aspect, there is no need to provide another sensor electrode for receiving a detection signal, around the multiple first common electrodes and around the multiple second common electrodes. Therefore, the area around the display surface of each of the first display device and the second display device can be made smaller.

While various embodiments have been described herein above, it is to be appreciated that various changes in form and detail may be made without departing from the spirit and scope of the invention(s) presently or hereafter claimed.

1. A detection device that performs detection of proximity of an object to a display device, the display device comprising a common electrode group including a plurality of common electrodes that are arranged in a matrix and used for both image display and touch detection, the common electrode group including a first group that includes a plurality of common electrodes and also including a second group that includes a plurality of common electrodes different from those of the first group, the detection device comprising:
a drive circuit that supplies a drive signal to a plurality of common electrodes included in the first group; and
a detection circuit that performs detection of proximity of an object to the display device, based on a detection signal received from a plurality of common electrodes included in the second group.

2. The detection device according to claim 1, wherein
the common electrode group includes a third group including a plurality of common electrodes located between a plurality of common electrodes included in the first group and a plurality of common electrodes included in the second group, and
the drive circuit does not supply the drive signal to a plurality of common electrodes included in the second group and a plurality of common electrodes included in the third group.

3. The detection device according to claim 1, wherein
the second group includes a plurality of first subgroups, and
the detection circuit performs detection of a first subgroup to which there was proximity of an object, from among the plurality of first subgroups.

4. The detection device according to claim 3, wherein
the first subgroup includes one or more common electrodes,
the detection device further comprises a control circuit that generates a plurality of second subgroups by dividing a plurality of common electrodes that include the one or more common electrodes included in the first subgroup and one or more common electrodes that is not included in the first subgroup, and
the detection circuit performs detection of a second subgroup to which there was proximity of an object, from among the plurality of second subgroups, based on a detection signal received from one or more common electrodes included in the plurality of second subgroups.

5. The detection device according to claim 4, wherein
when generating the plurality of second subgroups, the control circuit changes grouping such as to increase the number of common electrodes included in the first group.

6. The detection device according to claim 1, wherein
the second group includes a common electrode located in an edge part in the common electrode group.

7. The detection device according to claim 1, wherein
a number of common electrodes included in the first group is larger than a number of common electrodes included in the second group.

8. The detection device according to claim 3, wherein the plurality of first subgroups include:
a first subgroup that includes one or more common electrodes located in an upper edge part of a screen of the display device, in the common electrode group;
a first subgroup that includes one or more common electrodes located in a lower edge part of the screen, in the common electrode group;
a first subgroup that includes one or more common electrodes located in a left edge part of the screen, in the common electrode group; and
a first subgroup that includes one or more common electrodes located in a right edge part of the screen, in the common electrode group.

9. The detection device according to claim 1, wherein
the drive circuit supplies a drive signal to a plurality of common electrodes in the common electrode group in a first mode,
the detection circuit performs detection of a touch by an object on the display device in the first mode, based on a detection signal received from a plurality of common electrodes in the common electrode group,
the drive circuit supplies a drive signal to a plurality of common electrodes included in the first group in a second mode, and
the detection circuit performs detection of proximity of an object to the display device in the second mode, based on a detection signal received from a plurality of common electrodes included in the second group.

10. The detection device according to claim 9, wherein
the second mode is selected in a standby state in which no image is displayed on the display device, and when the detection circuit has detected proximity of an object to the display device in the second mode, the first mode is selected.

11. The detection device according to claim 10, wherein
the detection circuit identifies a position where an object was in proximity to the display device in the second mode, and
based on the identified position, the display content on the display device in the first mode is determined.

12. A detection device that performs detection of proximity of an object to a display device, the display device comprising a common electrode group including a plurality of common electrodes that are arranged in a matrix and used for both image display and touch detection, the common electrode group including a first group that includes a plurality of common electrodes and also including a second group that includes a plurality of common electrodes different from those of the first group, the detection device comprising:
a drive circuit that supplies a drive signal to a plurality of common electrodes included in the first group; and
a detection circuit that performs detection of proximity of an object to the display device based on a detection signal, wherein
on a display surface of the display device, a dial, which is rotatable, is disposed to overlap at least one common electrode included in the second group,
at a position on the dial that faces the display surface, an electric conductor is disposed, and
the detection circuit receives the detection signal from the electric conductor.

13. The detection device according to claim 12, wherein
the drive circuit does not supply the drive signal to a plurality of common electrodes included in the second group.

14. The detection device according to claim 12, wherein
the drive circuit supplies a drive signal to a plurality of common electrodes in the common electrode group in a first mode,
the detection circuit performs detection of a touch by an object on the display device and detection of the position of the electric conductor in the first mode, based on a detection signal received from a plurality of common electrodes in the common electrode group,
the drive circuit supplies a drive signal to a plurality of common electrodes included in the first group in a second mode, and
the detection circuit performs detection of proximity of an object to the display device in the second mode, based on a detection signal received from the electric conductor.

15. The detection device according to claim 12, wherein
a number of common electrodes included in the first group is larger than a number of common electrodes included in the second group.

16. A detection device that performs detection of proximity of an object to at least one of a first display device or a second display device disposed adjacent to the first display device, the first display device comprising a plurality of first common electrodes that are arranged in a matrix and used for both image display and touch detection, the second display device comprising a plurality of second common electrodes that are arranged in a matrix and used for both image display and touch detection, the detection device comprising:
a drive circuit that supplies a drive signal to at least one of the plurality of first common electrodes; and
a detection circuit that performs detection of proximity of an object to at least one of the first display device or the second display device, based on a detection signal received from at least one of the plurality of second common electrodes.

17. The detection device according to claim 16, wherein
the first display device includes a first group that includes the plurality of first common electrodes,
the second display device includes a common electrode group that includes the plurality of second common electrodes,
the common electrode group includes a second group that includes a plurality of second common electrodes located on the first display device side, and a third group that includes a plurality of second common electrodes different from those of the second group,
the drive circuit supplies a drive signal to a plurality of first common electrodes included in the first group, and
the detection circuit performs detection of proximity of an object to at least one of the first display device or the second display device, based on a detection signal received from a plurality of second common electrodes included in the second group.

18. The detection device according to claim 17, wherein
a number of first common electrodes included in the first group is larger than a number of second common electrodes included in the second group.

19. The detection device according to claim 16, wherein
the first display device includes a first common electrode group that includes the plurality of first common electrodes,
the first common electrode group includes a first group that includes a plurality of first common electrodes, and a second group that includes a plurality of first common electrodes different from those of the first group,
the second display device includes a second common electrode group that includes the plurality of second common electrodes,
the second common electrode group includes a third group that includes a plurality of second common electrodes, and a fourth group that includes a plurality of second common electrodes different from those of the third group,
the drive circuit supplies a drive signal to a plurality of first common electrodes included in the first group and to a plurality of second common electrodes included in the third group, and
the detection circuit performs detection of proximity of an object to the first display device based on a detection signal received from a plurality of first common electrodes included in the second group and also performs detection of proximity of an object to the second display device based on a detection signal received from a plurality of second common electrodes included in the fourth group.

20. The detection device according to claim 16, wherein
the drive circuit supplies a drive signal to the plurality of first common electrodes and the plurality of second common electrodes in a first mode,
the detection circuit performs, in the first mode, detection of a touch by an object on the first display device based on a detection signal received from the plurality of first common electrodes and also performs detection of a touch by an object on the second display device based on a detection signal received from the plurality of second common electrodes,
the drive circuit supplies a drive signal to at least one of the plurality of first common electrodes in a second mode, and
the detection circuit performs detection of proximity of an object to at least one of the first display device or the second display device in the second mode, based on a detection signal received from at least one of the plurality of second common electrodes.
